(19) United States
(12) Patent Application Publication
(10) Pub. No.: US 2022/0061360 A1
(43) Pub. Date: Mar. 3, 2022

(54) HEALTH FUNCTIONAL BEVERAGE

(71) Applicant: Anca-Gabriela Jucker, Mödling (AT)

(72) Inventor: Anca-Gabriela Jucker, Mödling (AT)

(21) Appl. No.: 17/414,306

(22) PCT Filed: Dec. 16, 2019
(86) PCT No.: PCT/EP2019/085379

§ 371 Date: Jun. 15, 2021

(30) Foreign Application Priority Data
Dec. 17, 2018 (EP) 18212912.2

(51) Int. Cl. A23L 2/60; A23L 2/68; A23L 2/66

(52) U.S. Cl. CPC A23L 2/60; A23L 2/66; A23L 2/68

(57) ABSTRACT

The invention relates to functional beverages which improve the well-being of the consumer. The invention specifically relates to a health functional beverage comprising Moringa leaf extract and Withania somnifera extract.

### FIELD OF THE INVENTION

The invention relates to functional beverages which improve the well-being of the consumer for a balanced life.

### BACKGROUND ART

Beverages have the primary function to satisfy the thirst of a consumer, a secondary function of supplying nutrition and a tertiary function of contributing in disease prevention and health improvement due to a body modulating function provided by various bioactive components contained in the beverage. Additionally, beverages should provide joyful feeling by taste, aroma, and physical properties.

Functional foods and beverages are becoming increasingly important to the aging cohort as they seek foods that may benefit their health long-term and prevent the onset of non-communicable diseases. Internationally health functional beverage markets have been focused on preventing diseases and improving health through a body modulating function of a beverage as the population ages. Also, the tendency of rapidly growing health functional beverage markets could be observed.

Functional beverages are typically intended to convey a health benefit. Functional beverages may include ingredients like herbs, vitamins, minerals, nootropics, amino acids, or additional raw fruit or vegetables. Examples of functional beverages include sports and performance drinks, energy drinks, ready to drink (RTD) teas, smart drinks, enhanced fruit drinks, soy beverages, and enhanced water.

There are already health and beauty drinks made from the Superfood Moringa from the Moringa tree on the market. Further, also WO2013/118094 discloses a beverage containing Moringa powder. But until now there has not been a ready-to-drink beverage made from Moringa and Withania which is also a superfood. The combination of Moringa and Withania conveys additional benefits to the consumer as described herein.

WO2012056475 discloses a composition for improving sexual health. The composition may comprise different herbal extracts, such as for example, Mucuna pruriens, Withania somnifera, Tribulus terrestes, Myristica fragrans, Asparagus racemosus, Emblica officianalis, Chlorophytum borivillianum, Moringa oleifera, Peuraria tuberosa, Ipomea digitata and Vitis vinifera and purified asphalt as a mineral. The composition is formulated as a capsule comprising said ingredients.

### SUMMARY OF INVENTION

The object of the present invention is to provide an alternative formulation of a functional beverage with improved health benefits for the consumer.

This object is solved according to the invention by a beverage comprising an extract from Moringa and Withania.

The present invention provides a health functional beverage comprising 0.1-1 g/L Moringa leaf extract, 0.1-1 g/L Withania somnifera extract and additional ingredients comprising at least one of a sweetener, a flavoring agent, an acidifier, vitamins and minerals, or any mixtures thereof.

A further embodiment of the invention relates to the beverage as described herein, wherein the beverage comprises 0.2-0.7 g/L Moringa leaf extract and 0.2-0.7 g/L Withania somnifera extract.

A further embodiment of the invention relates to the beverage as described herein, wherein the acidifier is citric acid.

A further embodiment of the invention relates to the beverage as described herein, wherein the sweetener is an artificial sweetener and/or high intensity sweetener.

One embodiment of the invention relates to the beverage as described herein, wherein the sweetener is selected from the group consisting of neotame, cyclamate, alitame, steviside/stevia, sucralose and acesulfame K, or a mixture thereof.

A further embodiment of the invention relates to the beverage as described herein, wherein the flavoring agent is selected from the group of natural or naturally identical fruity, herbal, or spicy aroma.

A further embodiment of the invention relates to the beverage as described herein, wherein the flavoring agent is selected from the group consisting of lime, lemon, orange, tangerine, raspberry, apple, pear, peach, blackberry, blueberry, elderberry, pomegranate, strawberry fruits, hibiscus aroma, or any combinations thereof.

A further embodiment of the invention relates to the beverage as described herein further comprising passion flower extract, Griffonia simplicifolia extract, Calamansi extract, and/or one or more proteins.

A further embodiment of the invention relates to the beverage as described herein, wherein the protein is a collagen hydrolysate.

A further embodiment of the invention relates to the beverage as described herein, wherein the beverage comprises 10 to 100 mg/L protein.

One embodiment of the invention relates to the beverage as described herein, wherein the beverage is a packaged ready-to-drink beverage.

One embodiment of the invention relates to the beverage as described herein for use in reducing stress, improving the mood, reducing anxiety, increasing relaxation, improving digestion, detoxification, reducing jet lag, and/or regeneration. The functional health beverage composition is specifically useful in assisting of a balanced life.

One embodiment of the invention relates to a health functional composition according as described herein comprising (by weight):
85 to 98% water;
0.01 to 0.1% Moringa leaf extract,
0.01 to 0.1% Withania somnifera extract,
0.1 to 1.0% flavors;
0.01 to 0.1% sweetener;
0.01 to 0.1% vitamins and minerals;
0.1 to 1.0% acidifier; and optionally
1.0 to 10% protein.

A further embodiment of the invention relates to a health functional composition according as described herein comprising (by weight): 85 to 98% water;
0.01 to 0.1% Moringa leaf extract;
0.01 to 0.1% Withania somnifera extract;
0.01 to 1.0% Passionflower extract;
0.01 to 0.1% Griffonia extract;
0.1 to 1.0% flavors;
0.01 to 0.1% sweetener;
0.01 to 0.1% vitamins and minerals; and
0.1 to 1.0% acidifier.

A further embodiment of the invention relates to a health functional composition according as described herein comprising (by weight):
85 to 98% water;
0.01 to 0.1% Moringa leaf extract;
0.01 to 0.1% Withania somnifera extract;
0.1 to 1.0% Calamansi extract;
0.1 to 1.0% flavors;
0.01 to 0.1% sweetener;
0.01 to 0.1% vitamins and minerals; and
0.1 to 1.0% acidifier.

A further embodiment of the invention relates to a health functional composition according as described herein comprising (by weight):
85 to 98% water;
0.01 to 0.1% Moringa leaf extract;
0.01 to 0.1% Withania somnifera extract;
0.01 to 1.0% Passionflower extract;
0.01 to 0.1% Jasmin extract;
0.1 to 1.0% flavors;
0.01 to 0.1% sweetener;
0.01 to 0.1% vitamins and minerals; and
0.1 to 1.0% acidifier.

A further embodiment of the invention relates to a health functional composition according as described herein comprising (by weight):
85 to 98% water;
0.01 to 0.1% Moringa leaf extract,
0.01 to 0.1% Withania somnifera extract,
0.1 to 1.0% flavors;
0.01 to 0.1% sweetener;
0.01 to 0.1% vitamins and minerals;
0.1 to 1.0% acidifier; and
1.0 to 10% collagen hydrolysate.

A further embodiment of the invention relates to a health functional beverage as described herein which is devoid of asphaltum.

### BRIEF DESCRIPTION OF DRAWINGS

FIG. 1 shows to the regulation of the heart rate variability in the conducted studies.

### DESCRIPTION OF EMBODIMENTS

The present invention relates to a functional beverage comprising at least extracts from Moringa and Withania and further ingredients such as for example a sweetener, a flavoring agent, an acidifier, vitamins and minerals, or any mixtures thereof.

Moringa is a plant that is native to the sub-Himalayan areas of India, Pakistan, Bangladesh, and Afghanistan. It is also grown in the tropics. The leaves, bark, flowers, fruit, seeds, and root are used to make medicine.

Moringa is an important food source in some parts of the world. Because it can be grown cheaply and easily, and the leaves retain lots of vitamins and minerals when dried, moringa is used in India and Africa in feeding programs to fight malnutrition. The immature green pods (drumsticks) are prepared similarly to green beans, while the seeds are removed from more mature pods and cooked like peas or roasted like nuts. The leaves are cooked and used like spinach, and they are also dried and powdered for use as a condiment.

Moringa is used in the treatment of anemia; arthritis and other joint pain (rheumatism); asthma; cancer; constipation; diabetes; diarrhea; epilepsy; stomach pain; stomach and intestinal ulcers; intestinal spasms; headache; heart problems; high blood pressure; kidney stones; fluid retention; thyroid disorders; and bacterial, fungal, viral, and parasitic infections. Moringa is also used to reduce swelling, increase sex drive (as an aphrodisiac), prevent pregnancy, boost the immune system, and increase breast milk production.

The leaves of Moringa oleifera are rich in minerals like calcium, potassium, zinc, magnesium, iron and copper. Vitamins like beta-carotene of vitamin A, vitamin B such as folic acid, pyridoxine and nicotinic acid, vitamin C, D and E also present in Moringa oleifera.

High quality Moringa leaf powder comprises vitamins, e.g. vitamin A, vitamin B1, B2 and B3 as well as vitamin C, vitamin E and K1, all essential amino acids, anti-inflammatory substances, antioxidants and a very high concentration of omega-3, -6 and -9 fatty acids. From all plants analyzed so far, Moringa contains the highest concentration of chlorophyll, the “anti-aging hormone” zeatin and many salvestrols.

Thus, Moringa is clearly a beneficial supplement to a consumer's nutrition.

In one embodiment of the invention the total amount of the Moringa extract in the functional beverage is typically in the range of 0.01 to 0.1% (w/w). For example, the total amount of the Moringa extract may be in the range of 0.02-0.075% w/w), or about 0.05% (w/w).

Ashwagandha is one of the most important herbs in Ayurveda. Its botanical name is Withania somnifera, and it's also known by several other names, including Indian ginseng and winter cherry.

The Withania somnifera extract has many bioactive compounds and thereby exerts antioxidant, anti-inflammatory, and immunomodulatory activities. The plant extract and its bioactive compounds are used in the prevention and treatment of many diseases, such as arthritis, impotence, amnesia, anxiety, cancer, neurodegenerative and cardiovascular diseases, and others.

The main phytochemical constituents are withanolides—which are triterpene lactones—withanolides, withaferin A, alkaloids, steroidal lactones, tropine, and cuscohygrine.

The biologically active chemical constituents are alkaloids (isopelletierine, anaferine), steroidal lactones, saponins containing an additional acyl group (sitoindoside VII and VIII), and withanolides with a glucose at carbon 27 (sitoindoside IX and X). Withania somnifera is also rich in iron.

In one embodiment of the invention the total amount of the Withania somnifera extract in the functional beverage is typically in the range of 0.001 to 0.1% (w/w). For example, the total amount of the Withania somnifera extract may be in the range of 0.005-0.05% (w/w).

Griffonia simplicifolia is a West African shrub. Griffonia simplicifolia is the largest source of the compound 5-HTP. Its seeds contain up to 20% 5-HTP, by weight. Studies done on Griffonia simplicifolia suggest that when supplemented as an herb, it may rival the effects of supplementing 5-HTP in isolation.

5-HTP (5-Hydroxytryptophan) is a chemical by-product of the protein building block L-tryptophan. Griffonia simplicifolia seeds are valuable sources of 5-HTP which is used for sleep disorders such as insomnia, depression, anxiety, migraine and tension-type headaches, fibromyalgia, obesity, premenstrual syndrome (PMS), premenstrual dysphoric disorder (PMDD), attention deficit-hyperactivity disorder (ADHD), seizure disorder, and Parkinson's disease.

Griffonia seed also may raise serotonin levels in the brain. Serotonin is important in regulating brain chemistry and is especially important in problems such as depression, insomnia, and eating disorders. Thus, supplementing nutrition with Griffonia seed may raise serotonin levels and thus provide relief from depression and insomnia.

Accordingly, in one embodiment of the invention the total amount of the Griffonia extract in the functional beverage is typically in the range of 0.01 to 0.1% (w/w). For example, the total amount of the Griffonia extract may be in the range of 0.015-0.05% (w/w), or is about 0.02% (w/w).

Passion flower is a climbing vine that is native to the southeastern United States, and Central and South America. The above ground parts pf the passion flower are used to make medicine.

Passion flower may alleviate sleep problems (insomnia), anxiety, adjustment disorder, attention deficit-hyperactivity disorder (ADHD), pain, fibromyalgia, relieving opioid withdrawal symptoms, reducing anxiety and nervousness before surgery, and heart failure.

Accordingly, in one embodiment of the invention the total amount of the Passion flower extract in the functional beverage is typically in the range of 0.01 to 0.1% (w/w). For example, the total amount of the Passion flower extract may be in the range of 0.015-1.0% (w/w), or in the range of 0.02-0.75% (w/w), or in the range of 0.025-0.5% (w/w), or is about 0.05% (w/w).

Calamansi also known as Calamondin Citrofortunella microcarpa belongs to the Rutaceae family. Calamansi is a popular citrofotunella; this means it is an intergenetic hybrid between the genes of a citrus and Kumquat. Calamansi is bountiful with goodness of appeal, nutrients and taste. This tangy sour fruit rich in citric acid is often a key ingredient in preparing ice cream, sorbets, jello, juice, soft drinks, nectar, jelly, gummy candies, sauces, vinaigrettes, fruit preserves and yogurt.

Calamansi juice has the ability of detoxifying on the body, to boost the immune system, soothe acidity in the stomach, aid in weight loss, stimulate growth and repair, bleach the skin, detoxify the body, lower cholesterol, manage diabetes, and treat respiratory infections, among others.

Jasmine is believed to have originated in the Himalayas of western China, a country where this delicate, fragrant flower is known as the “Queen of the Flowers”. Jasmine essential oil has been used in many parts of Asia as a natural remedy for depression, anxiety, stress and insomnia for thousands of years. Jasmine is rich in antioxidants that interact with gastrointestinal enzymes to facilitate better nutrient absorption and promote healthy bowel function. It also functions to promote the growth of good bacteria in the gut and has been found to eliminate harmful bacteria.

The antispasmodic qualities of Jasmine make it helpful to relieve indigestion, stomach cramps and soothe inflammation.

The uplifting scent of Jasmine essential oil has been proven to improve mood, de-stress and bring anxiety down to a more manageable level. Jasmine essential oil, when used in aromatherapy massage, increased behavior arousal and may significantly increases breathing rate, blood oxygen saturation and blood pressure, leading a more alert feeling. This stimulating effect could help to alleviate depression and anxiety whilst uplifting the mood.

Accordingly, in one embodiment of the invention the total amount of the Jasmin extract in the functional beverage is typically in the range of 0.01 to 0.1% (w/w). For example, the total amount of the Jasmin extract may be in the range of 0.015-0.05% (w/w), or is about 0.02% (w/w).

Vitamin C is a crucial element in collagen production, a compound needed to create every tissue, muscle fiber, and cell in the body. Due to the high amount of vitamin C Calamansi juice can deliver a burst of ascorbic acid that will increase your body's ability to grow, as well as repair damage from injury, illness or surgery.

Due the blood sugar-moderating effects of Calamansi juice it can help to regulate the release of glucose and insulin into the bloodstream, which is excellent news for those suffering from diabetes or those at risk of developing the disease.

Calamansi juice has the ability to boost the metabolism and to eliminate many of the toxins in the body that can contribute to fat storage. By increasing metabolic speed, this Calamansi juice can improve passive fat-burning throughout the day, while detoxifying the body will help all of the body organ systems run more smoothly and function properly.

In some embodiment of the invention the total amount of the Calamansi extract in the functional beverage is typically in the range of 0.1 to 1.0% (w/w). For example, the total amount of the Calamansi extract may be in the range of 0.25-0.75% (w/w), or is about 0.5% (w/w).

It has been known for some time that advantageous effects in relation to the health of the skin, but also the hair and/or nails in a human can be achieved by the oral intake of protein composition, specifically of collagen hydrolysate. An improvement in the health of the skin in this context is taken to mean every positive influence on the natural properties and functions of the skin, it being possible for these properties and functions to be impaired both as a consequence of ageing and also, additionally, by various negative environmental influences. An intake of collagen hydrolysate also has an advantageous effect on the properties of hair and/or nails.

Collagen hydrolysate may increase the tonicity of the skin and/or may reduce the formation of wrinkles. These properties of the skin generally worsen as a result of ageing and as a consequence of environmental influences, such as, for example, UV radiation or toxic substances. As, in particular, the matrix proteins collagen and elastin are responsible for the tonicity and elasticity of the skin, their augmented synthesis, which is stimulated to a particular extent by the collagen hydrolysate used, can counteract these effects and the health of the skin can be significantly improved.

A further important aspect of use of a collagen hydrolysate is an increase of the moisture content of the skin. A substantial contribution to the ability of the skin to bind adequate quantities of moisture is made by the proteoglycans (for example versican, biglycan and decorin) contained in the extracellular matrix, the synthesis of which is also shown to be stimulated by the collagen hydrolysate. The moisture content of the skin can also be reduced by damaging environmental influences such as UV radiation, the moisture loss frequently being accompanied by less suppleness, chapping and excessive cornification of the skin.

Thus, according to a further aspect of the invention, the functional beverage comprises about 1 to 10% protein, or about 2.5 to 7.5%, or about 5% protein in the final formulation. In one embodiment of the invention, the protein is a collagen hydrolysate.

In one embodiment of the invention the high protein beverage has a total protein content of at least 2% (w/w) relative to the total weight of the beverage. In one embodiment, the beverage has a total protein content of at least 3% (w/w); preferably at least 4% (w/w); more preferably at least 5% (w/w) relative to the total weight of the beverage.

Additionally the beverage may comprise a sweetener. The beverage may comprise one or more of natural sweeteners, artificial sweeteners and/or high intensity sweeteners.

Sweeteners are sugar substitutes that provide a sweet taste like that of sugar while containing significantly less food energy than other sweeteners, making it a zero-calorie or low-calorie sweetener.

The term “sweetener” as used herein relates to a component of the beverage that confers a sweet taste when the beverage is ingested. Components suitable for conferring a sweet taste may be natural sweeteners or artificial sweeteners. Natural sugars are for example extracted and condensed form plants such as agave cacti, maple trees, sugar cane, coconut palms, sugar beets and corn. Suitable natural sweeteners include both sugars in the form of sugars (i.e. mono- and di-saccharides) and non-sugar sweeteners.

The sweetener may be a polyol sweetener. Non-limiting examples of useful polyol sweetener are maltitol, mannitol, lactitol, sorbitol, inositol, xylitol, threitol, galactitol or combinations thereof.

The high intensity sweetener may be neotame, cyclamate, alitame, steviside/stevia, sucralose and/or acesulfame K. The high intensity sweeteners in the functional beverage composition may be sucralose and/or acesulfame K.

In an embodiment of the invention, the total amount of the sweetener is typically in the range of 0.01 to 0.1% (w/w). For example, the total amount of the sweetener may be in the range of 0.05-0.5% (w/w). Alternatively, the total amount of the sweetener may be in the range of 0.075-0.25% (w/w).

The beverage according to the invention also comprises a flavoring agent.

Flavoring agents are key food additives with hundreds of varieties like fruit, nut, seafood, spice blends, vegetables and wine which are natural flavoring agents. Besides natural flavors there are chemical flavors that imitate natural flavors. Some examples of chemical flavoring agents are alcohols that have a bitter and medicinal taste, esters are fruity, ketones and pyrazines provide flavors to caramel, phenolics have a smoky flavor and terpenoids have citrus or pine flavor.

Suitable colorants within the scope of the invention are flavorants preferably obtained from edible plant or vegetable sources. In many cases, the flavorants also function as colorants. Examples of suitable flavorants and colorants are obtained from lime, lemon, orange, tangerine, raspberry, apple, pear, peach, blackberry, and strawberry fruits.

Other examples of flavorants/colorants suitable for the invention are the orange colorant obtained from yams, the hot/spicy flavor which comes from a water-soluble capsicum or other capsaicinoids that are naturally water soluble; flavorants that come from cold-water extracted chili varieties. Other suitable flavorants include extracts from olives including the antioxidants and anti-inflammatories oleocanthal and oleacin. Additional flavorants are cactus flavors obtained from the blue agave, for example, Repasado and Anejo flavors.

Further examples of flavoring agents include, but are not limited to, almond, apple, banana, blueberry, blackberry, caramel, citrus, cherry, chocolate, coconut, elderberry, grape, green tea, hibiscus, honey, lemon, licorice, lime, mango, maple, mint, orange, peach, pineapple, pomegranate, raisin, strawberry, tangerine, vanilla, watermelon and combinations thereof.

The total amount of the flavoring agent is typically in the range of 0.1 to 1.0% (w/w). For example, the total amount of the flavoring agent may be in the range of 0.15-0.75% (w/w). Alternatively, the total amount of the flavoring agent may be in the range of 0.15-0.5% (w/w).

In one embodiment, the functional beverage contains vitamins and minerals that provide fortification.

Suitable vitamins are for example vitamin A (retinols and carotenoids), vitamin B1 (thiamine), vitamin B2 (riboflavin), vitamin B3 (niacin), vitamin B5 (pantothenic acid), vitamin B6 (pyridoxine), vitamin B7 (biotin), vitamin B9 (folic acid or folate), vitamin B12 (cobalamins), vitamin C (ascorbic acid), vitamin D (calciferols), vitamin E (tocopherols and tocotrienols), and vitamin K, (quinones). Suitable minerals are for example calcium, chromium, iodine, copper, phosphorus, iron, iodine, selenium, zinc, manganese, and molybdenum.

In some embodiments of the invention the vitamin and mineral mixture comprises vitamin B3, vitamin B5, vitamin B6, vitamin B12 and zinc.

In an embodiment of the invention, the total amount of the added vitamin and mineral mixture is typically in the range of 0.01 to 0.1% (w/w). For example, the total amount of the vitamin and mineral mixture may be in the range of 0.05-0.5% (w/w). Alternatively, the total amount of the vitamin and mineral mixture may be in the range of 0.075-0.25% (w/w).

The functional beverage mixture may further comprise an acidifier.

Suitable acidifiers are for examples organic acids, such as citric acid, malic acid, tartaric acid, acetic acid, phytic acid, lactic acid, fumaric acid, succinic acid, and gluconic acid, inorganic acid such as phosphoric acid, and sodium salt, calcium salt, or potassium salt of such organic or inorganic acid.

In one embodiment of the present invention, the acidifier comprises but not limited to lactic acid, glucono delta-lactone, phosphoric acid, ascorbic acid, acetic acid, citric acid, malic acid, hydrochloric acid, or combination of thereof.

The total amount of the acidifier is typically in the range of 0.1 to 1.0% (w/w). For example, the total amount of the acidifier may be in the range of 0.15-0.75% (w/w). Alternatively, the total amount of the acidifier may be in the range of 0.15-0.5% (w/w).

In one embodiment the acidifier is s citric acid in an amount of about 0.05% (w/w).

One embodiment of the invention relates to a functional beverage comprising Moringa leaf and Withania somnifera extract, Passionflower and Griffonia extract, a vitamin and mineral mixture, a sweetener, e.g., acesulfame potassium and sucralose, fruit aroma, e.g., a blueberry and elderberry flavorant agents, a colorant, e.g., a carrot colorant, an acidifier, e.g., citric acid, and water.

A functional beverage according to the present invention which comprises Moringa leaf extract, Withania somnifera extract, Passionflower extract, and Griffonia extract may specifically be beneficial as stress killer. This specific composition may be used in alleviating, preventing and/or even treating stress symptoms. Due to the beneficial ingredients this functional beverage may have an advantages effect of calming down stressed consumer, thus reducing stress and anxiety.

The functional beverage according to the invention which comprises Griffonia extract may also be indexed reducing jet-lag and travel feeling. Due to the active ingredient 5-HTP, which is a precursor of serotonin, the functional beverage may also have an anxiolytic-like effect. The additional ingredient Passionflower extract provides an anti-anxiety effect.

One embodiment of the invention relates to functional beverage comprising Moringa leaf and Withania somnifera extract, raw material of Calamansi, a vitamin and mineral mixture, a sweetener, e.g., acesulfame potassium and sucralose, fruit aroma, e.g., a tangerine flavorant agent, an acidifier, e.g., citric acid, and water.

A functional beverage according to the present invention which comprises Moringa leaf extract, Withania somnifera extract, and Calamansi may specifically be beneficial as in the reduction of oxidative stress. This specific composition may be used in alleviating, preventing and/or even treating stress symptoms, digestion problems, and may be effective in body detoxification. Due to the beneficial ingredients this functional beverage may have an advantages effect to the body to adapt easier and better to various stress situations.

One embodiment of the invention relates to functional beverage comprising Moringa leaf and Withania somnifera extract, proteins, e.g., a collagen hydrolysate, a vitamin and mineral mixture, a sweetener, e.g., acesulfame potassium and sucralose, fruit aroma, e.g., a tangerine flavorant agent, an acidifier, e.g., citric acid, and water.

A functional beverage according to the present invention which comprises Moringa leaf extract, Withania somnifera extract, and a high amount of proteins may specifically be beneficial as nourishing composition. This specific composition may be beneficial in recovering health and due to its high content of protein may even sometimes substitute a meal. Due to the beneficial ingredients this functional beverage may have an advantages effect to rejuvenate the body because it provides collagen which is essential for skin, bones and muscles.

In one embodiment of the invention the functional beverage comprises

0.01 to 0.1% (w/w) Moringa leaf extract,

0.01 to 0.1% (w/w) Withania somnifera extract,

0.01 to 0.1% (w/w) Passionflower extract,

0.01 to 0.1% (w/w) Griffonia extract,

0.01 to 0.1% (w/w) vitamins and minerals,

0.01 to 0.1% (w/w) sweetener,

0.1 to 1.0% (w/w) fruit aroma,

0.1 to 1.0% (w/w) citric acid monohydrate, and

water.

Another embodiment of the invention relates to the functional beverage comprising

0.01 to 0.1% (w/w) Moringa leaf extract,

0.01 to 0.1% (w/w) Withania somnifera extract,

0.1 to 1.0% (w/w) Calamansi extract,

0.01 to 0.1% (w/w) vitamins and minerals,

0.01 to 0.1% (w/w) sweetener,

0.1 to 1.0% (w/w) fruit aroma,

0.1 to 1.0% (w/w) citric acid monohydrate, and

water.

A further embodiment of the invention relates to the functional beverage comprising

0.01 to 0.1% (w/w) Moringa leaf extract,

0.01 to 0.1% (w/w) Withania somnifera extract,

1 to 10% collagen hydrolysate,

0.01 to 0.1% (w/w) vitamins and minerals,

0.01 to 0.1% (w/w) sweetener,

0.1 to 1.0% (w/w) fruit aroma,

0.1 to 1.0% (w/w) citric acid monohydrate, and

water.

### EXAMPLES

The Examples which follow are set forth to aid in the understanding of the invention but are not intended to, and should not be construed to limit the scope of the invention in any way.

### Example 1

The functional composition according to the invention comprises the following ingredient:

Moringa leaf extract (0.5 kg),

Withania somnifera extract (0.10 kg),

Passionflower extract (0.50 kg),

Griffonia extract (0.20 kg),

vitamins and minerals (0.50 kg)

a sweetener (0.16 kg),

fruit aroma (2.00),

citric acid monohydrate (6 kg), and

water (135 L)

The composition is pasteurized, and the final beverage bottled.

### Example 2

The functional composition according to the invention comprises the following ingredient:

Moringa leaf extract (0.5 kg),

Withania somnifera extract (0.2 kg),

Calamansi extract (5.0 kg),

vitamins and minerals (0.5 kg)

a sweetener (0.18 kg),

fruit aroma (0.30 kg),

citric acid monohydrate (6 kg), and

water (132 L)

The composition is pasteurized, and the final beverage bottled.

### Example 3

The functional composition according to the invention comprises the following ingredient:

Moringa leaf extract (0.5 kg),

Withania somnifera extract (0.1 kg),

collagen hydrolysate (50.0 kg),

vitamins and minerals (0.5 kg),

magnesium citrate (6.62 kg),

a sweetener (0.18 kg),

fruit aroma (3.80 kg),

citric acid monohydrate (7 kg), and

water (154 L)

The composition is pasteurized, and the final beverage bottled.

### Example 4

The functional composition according to the invention comprises the following ingredient:

Moringa leaf extract (0.5 kg),

Withania somnifera extract (0.10 kg),

Passionflower extract (3.00 kg),

ex extract (3.00 kg)

vitamins and minerals (0.50 kg)

a sweetener (0.16 kg),

fruit aroma (2.00 kg),

citric acid monohydrate (4 kg), and

water (191 L)

The composition is pasteurized, and the final beverage bottled.

### Example 5

In prospective, randomized, placebo controlled, part. cross-over studies the combination of Moringa oleifera and Withania somnifera extracts comprised in different beverages was investigated.

Probands: 30 adults (10 females (aged 28 to 36), and 20 males (aged 27-38)). During the study period the probands did not intake any herbal food.

Beverages for the placebo group are devoid of the extracts. Beverages for the single groups comprise either Moringa leaf extract of Withania somnifera extract. All other ingredients are identical, e.g., specifically with regard to the flavorings and color.

### Study 1: Harmony

Study Design:

Beverages comprising following extracts: Moringa, Withania, Griffonia s. (natural 5 HIP) and Passionflower

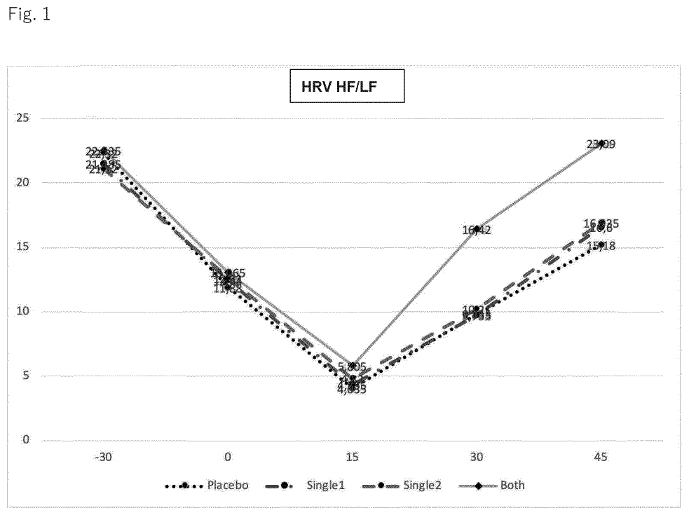

Study population: 30 people received the beverage with the extracts (treatment group) and 10 people without extract ingredients (placebo group), 10 people without Moringa extract ingredients (single1 group), and 10 people without Withania extract ingredients (single2 group) (see FIG. 1).

Intake: 4 weeks, once daily

Duration: 9 months

Main topic: Evaluation according to standard questionnaire regarding stress, memory, mood swings, depression

### Study 2: Regeneration

Study Design:

Beverages comprising following extracts: Moringa, Withania, and collagen hydrolysate (adequate collagen for health)

Study population: 30 people received the beverage with the extracts (treatment group) and 30 people without extract ingredients (placebo group)

Intake: 2 weeks, once daily

Duration: 6-9 months

Main topic: Evaluation according to standard questionnaire regarding regeneration after physical activity, operation, or injury.

### Study 3: Rebalance

Study Design:

Beverages comprising following extracts: Moringa and Withania

Study population: 20 people received the beverage with the extracts (treatment group) and 20 people without extract ingredients (placebo group)

Intake: 2 weeks, once daily

Duration: 6 months

Main topic: Evaluation according to standard questionnaire regarding fast food, digestion, fundamental blood check.

### Study 4: Voyage

Study Design:

Beverages comprising following extracts: Moringa, Withania, Passionflower

Study population: 10 people received the beverage with extracts (treatment group) and 10 people without extract ingredients (placebo group)

Intake: twice 1 week, 2 times daily

Duration: 9 months

Main topic: Evaluation according to standard questionnaire regarding performance, regeneration after time delay (jetlag), and anxiety.

### Results

The combination of Moringa oleifera and Withania sominifera extracts showed a significant superior effect on the positive regulation of the heart rate variability (HRV) compared to the single extracts and placebo groups (see FIG. 1). The combination optimizes recreation after standardized stress significantly. LF refers to low frequency and HF refers to high frequency. The Ratio of High Frequency (HF) to Low Frequency (LF) is considered to be indicative of sympathetic to parasympathetic autonomic balance.

For determining stress in a standardized way a variety of instruments have been designed to help measure individual stress levels. One of these is called the Perceived Stress Scale.

The Perceived Stress Scale (PSS) is a classic stress assessment instrument. The tool, while originally developed in 1983, remains a popular choice for helping us understand how different situations affect our feelings and our perceived stress. The questions in this scale ask about your feelings and thoughts during the last month. In each case, you will be asked to indicate how often you felt or thought a certain way. Although some of the questions are similar, there are differences between them and you should treat each one as a separate question. The best approach is to answer fairly quickly. That is, don't try to count up the number of times you felt a particular way; rather indicate the alternative that seems like a reasonable estimate.

In summary, following items are observed:

no significant difference in age comparing male and female;

initial and reactive heartbeat similar in all 4 groups;

HRV reacts to standardized stress by value decrease;

maximum decrease of HRV in placebo group;

decrease in both single substance groups not significant;

less decrease of HRV in group 4 (both substances), p=n.s.; and

surprisingly, high significant increase of HRV after standardized stress

1. A health functional beverage comprising 0.1-1 g/L Moringa leaf extract, 0.1-1 g/L Withania somnifera extract and additional ingredients comprising at least one of a sweetener, a flavoring agent, an acidifier, vitamins and minerals, or any mixtures thereof.

2. The beverage of claim 1, wherein the beverage comprises 0.2-0.7 g/L Moringa leaf extract and 0.2-0.7 g/L Withania somnifera extract.

3. The beverage of claim 1, wherein the acidifier is citric acid.

4. The beverage of claim 1, wherein the sweetener is an artificial sweetener and/or a high intensity sweetener.

5. The beverage of claim 1, wherein the sweetener is selected from the group consisting of neotame, cyclamate, alitame, steviside/stevia, sucralose and acesulfame K, and a mixture thereof.

6. The beverage of claim 1, wherein the flavoring agent is a fruity, herbal, or spicy aroma.

7. The beverage of claim 6, wherein the flavoring agent is selected from the group consisting of lime, lemon, orange, tangerine, raspberry, apple, pear, peach, blackberry, blueberry, elderberry, pomegranate, strawberry, hibiscus aroma, and any combinations thereof.

8. The beverage of claim 1, further comprising passionflower extract, Griffonia simplicifolia extract, Calamansi extract, and/or one or more proteins.

9. The beverage of claim 8, wherein the one or more proteins comprise a collagen hydrolysate.

10. The beverage of claim 8, wherein the beverage comprises 10 to 100 mg/L protein.

11. The beverage of claim 1, wherein the beverage is a packaged ready-to-drink beverage.

12. A method of reducing stress, improving mood, reducing anxiety, increasing relaxation, improving digestion, detoxification, reducing jet lag, and/or regeneration comprising the step of administering an effective amount of the beverage of claim 1 to a subject.

13. The beverage of claim 1, wherein the beverage comprises:
85 to 98% water;
0.01 to 0.1% (w/w) Moringa leaf extract,
0.01 to 0.1% (w/w) Withania somnifera extract,
0.1 to 1.0% flavors;
0.01 to 0.1% (w/w) sweetener;
0.01 to 0.1% (w/w) vitamins and minerals;
0.1 to 1.0% (w/w) acidifier; and optionally
1.0 to 10% (w/w) protein.

14. The beverage of claim 13, wherein the beverage further comprises one or more of the following:
0.01 to 1.0% (w/w) passionflower extract,
0.01 to 0.1% (w/w) Griffonia extract,
0.01 to 1.0 (w/w) jasmine extract,
0.1 to 1.0% (w/w) fruit aroma, and/or
0.1 to 1.0% (w/w) citric acid monohydrate.

15. The beverage of claim 13, further comprising 0.1 to 1.0% (w/w) Calamansi extract.

16. The beverage of claim 13, wherein the beverage further comprises 1 to 10% collagen hydrolysate.

17. A method of reducing stress, improving the mood, reducing anxiety, increasing relaxation, improving digestion, detoxification, reducing jet lag, and/or regeneration comprising the step of administering an effective amount of the beverage of claim 13 to a subject.

18. The beverage of claim 14, further comprising 0.1 to 1.0% (w/w) Calamansi extract.
